(19) United States
(12) Patent Application Publication
(10) Pub. No.: US 2023/0291513 A1
(43) Pub. Date: Sep. 14, 2023

(54) METHOD AND APPARATUS FOR CARRIER CONTROL

(71) Applicant: Telefonaktiebolaget LM Ericsson (publ), Stockholm (SE)

(72) Inventors: Qi Zhang, Beijing (CN); Zhi Ge, Beijing (CN); Yi Wang, Beijing (CN)

(21) Appl. No.: 18/019,173

(22) PCT Filed: Aug. 5, 2020
(86) PCT No.: PCT/CN2020/107086

§ 371 Date: Feb. 1, 2023

(51) Int. Cl. H04L 5/00

(52) U.S. Cl. CPC H04L 5/0035; H04L 5/0098; H04L 5/0064; H04L 5/006

(57) ABSTRACT

Various embodiments of the present disclosure provide a method for carrier control. The method which may be performed by a network node comprises calculating first feedback latency of a terminal device with respect to the network node, based at least in part on a numerology of a candidate cell for the terminal device. The method may further comprise determining whether to select the candidate cell as a secondary cell of the terminal device, according to the first feedback latency.

### FIELD OF THE INVENTION

The present disclosure generally relates to communication networks, and more specifically, to a method and apparatus for carrier control.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long term evolution (LTE)/fourth generation (4G) networks and new radio (NR)/fifth generation (5G) networks are expected to achieve high traffic capacity and end-user data rate with lower latency. In order to meet dramatically increasing network requirements, one interesting option for communication technique development is to support flexible network configuration, e.g., carrier aggregation (CA) with adaptive numerology. The term “numerology” may be used to refer to some parameters related to the radio resources for signal transmissions, such as subcarrier spacing (SCS), the length or duration of a cyclic prefix (CP), the length or duration of an orthogonal frequency division multiplexing (OFDM) symbol, the number of symbols contained in a time slot, the time slot duration, etc. Carrier combinations or CA with different numerologies may be supported to achieve potentially network performance gain by flexible radio resource configuration.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Comparing to LTE numerology (e.g., SCS, symbol length, slot, etc.), one of outstanding differences in NR numerology is that a NR network may support multiple different types of SCS (e.g., 15 KHz, 30 KHz, 60 KHz, 120 KHz, etc.), while in an LTE network there may be only one type of SCS (e.g., 15 KHz). The NR network may also support carrier combinations such as CA with different numerologies to improve network throughput and cell coverage. However, application of CA with different numerologies may introduce extra transmission delay, e.g. larger hybrid automatic repeat request (HARQ) feedback delay in some scenarios. Therefore, it may be desirable to control carrier combinations or CA in a more efficient way.

Various embodiments of the present disclosure propose a solution for carrier control, which can enable a secondary cell (Scell) to be selected (e.g., for configuration/activation/scheduling, etc.) for a terminal device such as a user equipment (UE) adaptively, for example, according to HARQ latency related to numerologies of a primary cell (Pcell) and the Scell of the terminal device, so as to improve flexibility of CA configuration and enhance resource utilization without increasing transmission delay significantly.

It can be appreciated that selecting a Scell for a terminal device as described in this document may refer to configuring a Scell for a terminal device, activating a Scell configured for a terminal device, and/or scheduling a Scell activated for a terminal device. In addition, it also may be appreciated that one or more Scells may be selected for a terminal device according to different configurations.

According to a first aspect of the present disclosure, there is provided a method performed by a network node (e.g., a base station). The method comprises calculating first feedback latency of a terminal device with respect to the network node, based at least in part on a numerology of a candidate cell for the terminal device. In accordance with an exemplary embodiment, the method further comprises determining whether to select the candidate cell as a Scell of the terminal device, according to the first feedback latency.

In accordance with an exemplary embodiment, the first feedback latency may correspond to a carrier combination of the candidate cell and a Pcell of the terminal device.

In accordance with an exemplary embodiment, the first feedback latency may be further based at least in part on one or more of: a numerology of a Pcell of the terminal device; a frame pattern for the terminal device; and a capability of the terminal device.

In accordance with an exemplary embodiment, the calculation of the first feedback latency may comprise: estimating downlink channel processing time of the terminal device, according to the numerology of the candidate cell and a numerology of a Pcell of the terminal device; and calculating the first feedback latency according to the downlink channel processing time of the terminal device.

In accordance with an exemplary embodiment, the first feedback latency may be adjusted according to a frame pattern for the terminal device.

In accordance with an exemplary embodiment, the first feedback latency may be equal to a minimum number of slots from downlink scheduling of the terminal device by the network node to uplink feedback to the downlink scheduling by the terminal device.

In accordance with an exemplary embodiment, the candidate cell may be included in a cell list for the terminal device according to the first feedback latency.

In accordance with an exemplary embodiment, the network node may determine to select the candidate cell as the Scell of the terminal device, in response to the first feedback latency meeting one or more of:
the first feedback latency is lower than feedback latencies of the terminal device calculated for one or more cells different from the candidate cell;
the first feedback latency is lower than a first threshold; and
a difference between second feedback latency of the terminal device calculated for a Pcell of the terminal device and the first feedback latency is lower than a second threshold.

In accordance with an exemplary embodiment, selecting the candidate cell as the Scell of the terminal device may comprise: configuring the candidate cell as the Scell of the terminal device.

In accordance with an exemplary embodiment, the candidate cell may be configured as the Scell of the terminal device according to one or more of:
a first parameter to enable Scell configuration for the terminal device;
a traffic type of the terminal device; and
a quality of service (QoS) requirement of the terminal device during a first period of time.

In accordance with an exemplary embodiment, the candidate cell may be one of cells configured for the terminal device. In this case, selecting the candidate cell as the Scell of the terminal device may comprise: activating the candidate cell as the Scell of the terminal device.

In accordance with an exemplary embodiment, the candidate cell may be activated as the Scell of the terminal device according to one or more of:
a second parameter to enable Scell activation for the terminal device;
a traffic type of the terminal device; and
a QoS requirement of the terminal device during a second period of time.

In accordance with an exemplary embodiment, the candidate cell may be one of cells activated for the terminal device. In this case, selecting the candidate cell as the Scell of the terminal device may comprise: scheduling the candidate cell as the Scell of the terminal device.

In accordance with an exemplary embodiment, the candidate cell may be scheduled as the Scell of the terminal device according to one or more of:
a third parameter to enable Scell scheduling for the terminal device;
a traffic type of the terminal device; and
a QoS requirement of the terminal device during a third period of time.

In accordance with an exemplary embodiment, the method according to the first aspect of the present disclosure may further comprise: transmitting information about the Scell to the terminal device.

In accordance with an exemplary embodiment, the information about the Scell may be transmitted to the terminal device in one or more of:
a radio resource control (RRC) message;
a control element for medium access control (MAC CE); and
downlink control information (DCI).

In accordance with an exemplary embodiment, the method according to the first aspect of the present disclosure may further comprise: selecting one or more other candidate cells as Scells of the terminal device, according to feedback latencies of the terminal device which may be calculated based at least in part on numerologies of the one or more other candidate cells.

According to a second aspect of the present disclosure, there is provided an apparatus which may be implemented as a network node. The apparatus may comprise one or more processors and one or more memories comprising computer program codes. The one or more memories and the computer program codes may be configured to, with the one or more processors, cause the apparatus at least to calculate first feedback latency of a terminal device with respect to the network node, based at least in part on a numerology of a candidate cell for the terminal device. According to some exemplary embodiments, the one or more memories and the computer program codes may be configured to, with the one or more processors, cause the apparatus at least further to determine whether to select the candidate cell as a Scell of the terminal device, according to the first feedback latency.

In accordance with some exemplary embodiments, the one or more memories and the computer program codes may be configured to, with the one or more processors, cause the apparatus according to the second aspect of the present disclosure at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a network node. The apparatus may comprise a calculating unit and a determining unit. In accordance with some exemplary embodiments, the calculating unit may be operable to carry out at least the calculating step of the method according to the first aspect of the present disclosure. The determining unit may be operable to carry out at least the determining step of the method according to the first aspect of the present disclosure.

According to a fifth aspect of the present disclosure, there is provided a method performed by a terminal device (e.g., a UE). The method comprises receiving information about a Scell of the terminal device from a network node. The Scell may be selected for the terminal device by the network node according to first feedback latency of the terminal device with respect to the network node. The first feedback latency may be based at least in part on a numerology of the Scell. In accordance with an exemplary embodiment, the method further comprises determining the Scell of the terminal device according to the received information.

In accordance with an exemplary embodiment, the information about the Scell described according to the fifth aspect of the present disclosure may correspond to the information about the Scell described according to the first aspect of the present disclosure. Similarly, the first feedback latency described according to the fifth aspect of the present disclosure may correspond to the first feedback latency described according to the first aspect of the present disclosure.

In accordance with an exemplary embodiment, the first feedback latency may be related to downlink channel processing time of the terminal device. In an embodiment, the downlink channel processing time may be determined based at least in part on the numerology of the S cell and a numerology of a Pcell of the terminal device.

In accordance with an exemplary embodiment, the information about the Scell may indicate that the Scell is configured for the terminal device by the network node.

In accordance with an exemplary embodiment, the configuration of the Scell for the terminal device may be performed according to one or more of:
a first parameter to enable Scell configuration for the terminal device;
a traffic type of the terminal device; and
a QoS requirement of the terminal device during a first period of time.

In accordance with an exemplary embodiment, the Scell may be one of cells configured for the terminal device. In this case, the information about the Scell may indicate that the Scell is activated for the terminal device by the network node.

In accordance with an exemplary embodiment, the activation of the Scell for the terminal device may be performed according to one or more of:
a second parameter to enable Scell activation for the terminal device;
a traffic type of the terminal device; and
a QoS requirement of the terminal device during a second period of time.

In accordance with an exemplary embodiment, the Scell may be one of cells activated for the terminal device. In this case, the information about the Scell may indicate that the Scell is scheduled for the terminal device by the network node.

In accordance with an exemplary embodiment, the scheduling of the Scell for the terminal device may be performed according to one or more of:
a third parameter to enable Scell scheduling for the terminal device;
a traffic type of the terminal device; and
a QoS requirement of the terminal device during a third period of time.

In accordance with an exemplary embodiment, the terminal device may receive the information about the Scell in a RRC message, a MAC CE and/or DCI.

In accordance with an exemplary embodiment, the information about the Scell may also be related to one or more other Scells of the terminal device. In an embodiment, the one or more other Scells may be selected for the terminal device by the network node according to feedback latencies of the terminal device which may be based at least in part on numerologies of the one or more other Scells.

According to a sixth aspect of the present disclosure, there is provided an apparatus which may be implemented as a terminal device. The apparatus comprises one or more processors and one or more memories comprising computer program codes. The one or more memories and the computer program codes may be configured to, with the one or more processors, cause the apparatus at least to receive information about a Scell of the terminal device from a network node. The Scell may be selected for the terminal device by the network node according to first feedback latency of the terminal device with respect to the network node. The first feedback latency may be based at least in part on a numerology of the Scell. According to some exemplary embodiments, the one or more memories and the computer program codes may be configured to, with the one or more processors, cause the apparatus at least further to determine the Scell of the terminal device according to the received information.

In accordance with some exemplary embodiments, the one or more memories and the computer program codes may be configured to, with the one or more processors, cause the apparatus according to the sixth aspect of the present disclosure at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a terminal device. The apparatus may comprise a receiving unit and a determining unit. In accordance with some exemplary embodiments, the receiving unit may be operable to carry out at least the receiving step of the method according to the fifth aspect of the present disclosure. The determining unit may be operable to carry out at least the determining step of the method according to the fifth aspect of the present disclosure.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the first aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the first aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the fifth aspect of the present disclosure.

According to a twelfth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the fifth aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the fifth aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the fifth aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the first aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the first aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1A-1B are diagrams illustrating exemplary HARQ feedback according to some embodiments of the present disclosure;

FIG. 2 is a diagram illustrating exemplary HARQ feedback for carrier aggregation according to an embodiment of the present disclosure;

FIG. 3 is a diagram illustrating exemplary feedback configuration adjustment according to an embodiment of the present disclosure;

FIG. 4 is a flowchart illustrating a method according to some embodiments of the present disclosure;

FIG. 5 is a flowchart illustrating another method according to some embodiments of the present disclosure;

FIG. 6A is a block diagram illustrating an apparatus according to some embodiments of the present disclosure;

FIG. 6B is a block diagram illustrating another apparatus according to some embodiments of the present disclosure;

FIG. 6C is a block diagram illustrating a further apparatus according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

The concept of carrier aggregation (CA) is introduced by 3GPP in LTE Release 10. Carrier aggregation may refer to concatenation of multiple carriers. Application of carrier aggregation may increase bandwidth and consecutive data rate of the system. LTE Release 10 provides support for 5 component carriers (CCs). For example, LTE may support five bandwidth options, including 1.4 MHz, 3 MHz, 5 MHz, 10 MHz and 20 MHz. With the maximum bandwidth and 5 CCs, LTE may provide the maximum bandwidth of 100 MHz. LTE Release 13 (i.e. LTE Advanced-PRO) supports 32 CCs, and hence 640 MHz can be achieved. Compared to LTE, 5G/NR may support carrier aggregation with up to 16 CCs and up to 1 GHz. Carrier aggregation of LTE and 5G/NR carriers may also be possible, which is known as dual connectivity (DC).

One of the differences between 4G networks and 5G networks may be that in 5G/NR carrier aggregation, carriers can use different numerologies (e.g., SCS, slots, etc.). For example, 3GPP may support CA combinations like frequency range 1+frequency range 1 (FR1+FR1), frequency range 2+frequency range 2 (FR2+FR2), and even FR1 (below 6 GHz)+FR2 (above 6 GHz in mmW range). As an example, multiple transmission numerologies may be supported as given by Table 1, where Δf indicates SCS in KHz, and μ is the SCS index.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

As listed in Table 1, the SCS value 15 KHz corresponds to μ=0, the SCS value 30 KHz corresponds to μ=1, and so on. According to an exemplary embodiment, only the SCS values 15 KHz, 30 KHz and 60 KHz for FR1, and the SCS values 120 KHz and 240 KHz for FR2 may be applicable.

Some exemplary band combinations for inter-band NR CA between FR1 and FR2 are shown in Table 2.

TABLE 2

| NR CA Band | NR Band |
|---|---|
| CA_n8-n258 | n8, n258 |
| CA_n71-n257¹ | n71, n257 |
| CA_n77-n257¹ | n77, n257 |
| CA_n78-n257¹ | n78, n257 |
| CA_n79-n257¹ | n79, n257 |

NOTE 1:
Applicable for UE supporting inter-band carrier aggregation with mandatory simultaneous Rx/Tx capability.

Normally, there may be several benefits brought by downlink/uplink (DL/UL) carrier aggregation. For example, adding an extra carrier for data transmission may achieve higher DL/UL throughput of a UE. In addition, a carrier with lower band may have better coverage than a carrier with higher band, so the carrier aggregation by combining carriers with lower band and higher band may enhance cell coverage and thus is popular in 5G/NR networks. Although support of different numerologies in carrier aggregation can improve network throughput and coverage, it may cause larger HARQ feedback delay in some scenarios.

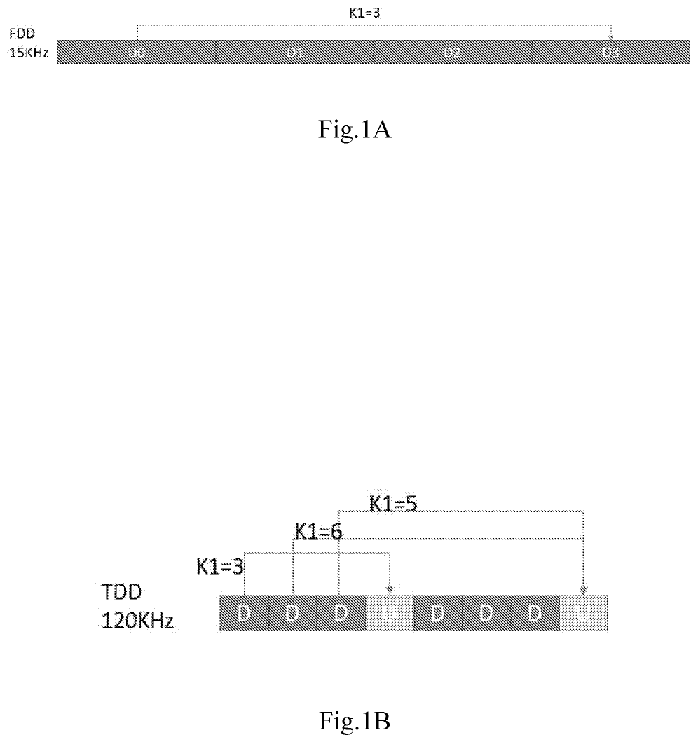

FIGS. 1A-1B are diagrams illustrating exemplary HARQ feedback according to some embodiments of the present disclosure. In an exemplary embodiment, if the SCS value for transmission of a UE (e.g. using frequency division duplex (FDD)) is 15 KHz, then for HARQ feedback on physical uplink control channel (PUCCH), the UE's physical downlink shared channel (PDSCH) processing time is 13 orthogonal frequency division multiplexing (OFDM) symbols, and for HARQ feedback on physical uplink shared channel (PUSCH), the UE's PDSCH processing time is 14 OFDM symbols. If the over-the-air (OTA) delay is considered, then the minimum number of slots from downlink scheduling of the UE (e.g., at slot D0 in FIG. 1A) to uplink feedback to the downlink scheduling by the UE (e.g., at slot D3 in FIG. 1A) is K1=3, as shown in FIG. 1A.

In another exemplary embodiment, if the SCS value for transmission of a UE (e.g. using time division duplex (TDD)) is 120 KHz, then for HARQ feedback on PUCCH, the UE's PDSCH processing time is 24 OFDM symbols, and for HARQ feedback on PUSCH, the UE's PDSCH processing time is 25 OFDM symbols. Considering TDD pattern with DL-DL-DL-UL (DDDU) as shown in FIG. 1B, the minimum K1 is 3.

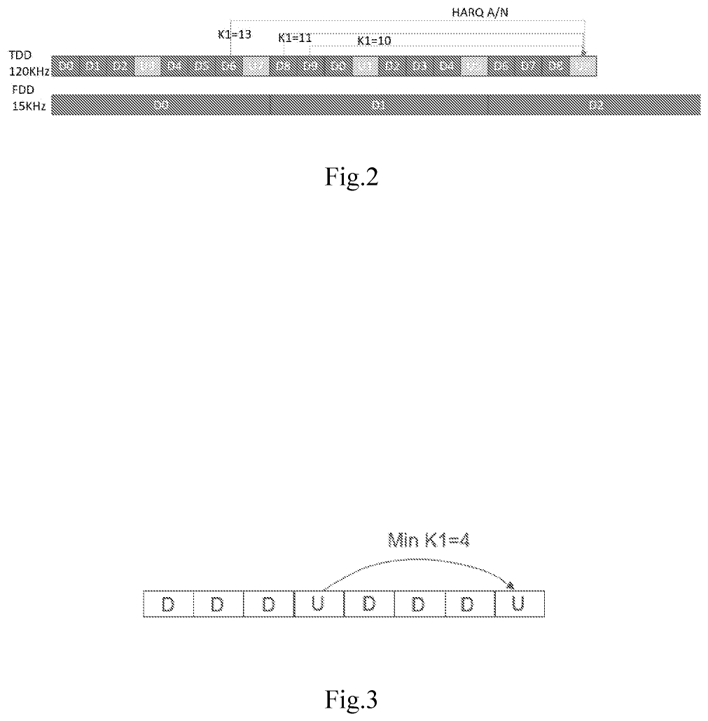

FIG. 2 is a diagram illustrating exemplary HARQ feedback for carrier aggregation according to an embodiment of the present disclosure. In an exemplary embodiment where the SCS values for 2CC carrier aggregation are 15 KHz and 120 KHz respectively, the UE's PDSCH processing time is the longest among the two carriers, i.e. 14 OFDM symbols with the SCS value of 15 KHz. Considering TDD pattern with DDDU as shown in FIG. 2, the minimum K1 is 10. It can be seen that for the multi-numerology carrier aggregation (e.g., DL only, or both DL and UL), the minimum HARQ feedback time of the UE for 120 KHz carrier is changed from 3 subframes to 10 subframes. For delay sensitive traffic like ultra-reliable and low latency communication (URLLC), the HARQ feedback time delay may be crucial for the overall traffic delay. Therefore, it may be desirable to control carrier aggregation in a more efficient way.

Various exemplary embodiments of the present disclosure propose a solution to enable a network node (e.g., a gNB, etc.) to control carrier combination or carrier aggregation for a UE, e.g., according to traffic type, QoS requirement, etc. By implementing various embodiments, the gNB may select one or more transmission carriers or Scells for the UE according to the corresponding HARQ latency. In this way, the gNB can determine the optimal carrier combination with lower feedback latency for the UE, which may benefit the UE with low latency requirement in the carrier aggregation scenario.

In accordance with an exemplary embodiment, before Scell configuration in radio resource control (RRC), a gNB may determine which candidate Scell may be selected for a UE as a serving cell. Generally, the S cell may be selected according to its supported multiple-input multiple-output (MIMO) layers, traffic load and/or supported bandwidth. Alternatively or additionally, the gNB may configure several measurement events to get channel quality information for Scell selection. In an embodiment, the gNB may prioritize all candidate Scells and select the Scell that can bring higher improvement on throughput for the UE.

In accordance with an exemplary embodiment, a gNB may select one or more Scells to be configured/activated/scheduled for a UE, according to HARQ latency. When performing Scell selection, the gNB may calculate HARQ latency for each Scell, e.g. based at least in part on the numerology (and optionally frame pattern) of the Pcell and/or Scell for the UE. As an example, the HARQ latency may be derived from the UE's PDSCH processing time that may depend on the Pcell's numerology and the Scell's numerology. In addition, the frame pattern may also be considered, because the UE may only transmit DL HARQ feedback to the gNB in an UL slot.

In accordance with an exemplary embodiment, the UE's PDSCH processing time T_{proc,1} may be calculated as below:

T_{proc,1}=((N₁+d_{1,1})(2048+144)κ2^{-μ})T_{c} (1)

where
N₁ is based on μ (e.g., μ in Table 5.3-1 and Table 5.3-2 of 3GPP technical specification (TS) 38.214 V16.2.0, where the entire content of this technical specification is incorporated into the present disclosure by reference) for UE processing capability 1 and 2 respectively;
μ is the subcarrier spacing index, which may correspond to the one of (μ_{PDCCH}, μ_{PDSCH}, μ_{UL}) resulting with the largest T_{proc,1};
μ_{PDCCH} corresponds to the subcarrier spacing of the physical downlink control channel (PDCCH) scheduling the PDSCH;
μ_{PDSCH} corresponds to the subcarrier spacing of the scheduled PDSCH;
μ_{UL} corresponds to the subcarrier spacing of the uplink channel with which the HARQ acknowledgement (HARQ-ACK) is to be transmitted;
d_{1,1} may depend on many factors like: UE processing capability, PDSCH mapping type, number of PDSCH symbols, etc., for example, d_{1,1}=0, if:
   HARQ feedback is sent on PUCCH;
   PDSCH mapping type A;
   The last PDSCH symbol is after 6-th symbol.
T_{c} may be calculated as T_{c}=1/(Δfₘₐₓ·N_{f}), where Δfₘₐₓ=480·10³ Hz and N_{f}=4096; and
The constant K may be calculated as κ=Tₛ/T_{c}=64, where Tₛ=1/(Δf_{ref}·N_{f,ref}), Δf_{ref}=15·10³ Hz and N_{f,ref}=2048, e.g. as defined in clause 4.1 of 3GPP TS 38.211 V16.2.0 (where the entire content of this technical specification is incorporated into the present disclosure by reference).

In accordance with an exemplary embodiment, the gNB may calculate the UE's PDSCH processing time for non-CA case and CA case respectively, e.g., according to formula (1). Assuming that the UE has processing capability 1 (which may be used to set N₁) and d_{1,1}=0, then the UE's PDSCH processing time nonCAT_{proc,1} for non-CA case may be calculated by μ referring to (μ_{PDCCH}, μ_{PDSCH}, μ_{UL}) of the Pcell's numerology. For CA case, the UE's PDSCH processing time scellₘCAT_{proc,1} for Scell candidate in may be calculated by μ referring to (μ_{PDCCH}, μ_{PDSCH}, μ_{UL}) of the Pcell's numerology and the Scell's numerology, where μ_{UL} is based on the Pcell's numerology, and (μ_{PDCCH}, μ_{PDSCH}) is based on the Scell's numerology.

According to an embodiment for the non-CA case with 120 KHz carrier, ρ=3, N₁=24, d_{1,1}=0, κ=Tₛ/T_{c}=64 and T_{c}=1/(Δfₘₐₓ·N_{f}), where Δfₘₐₓ=480·10³ Hz and N_{f}=4096, then the UE's PDSCH processing time nonCAT_{proc,1} may be calculated as below:

nonCAT_{proc,1}=(24*(2048+144)*64*2\hat{ }(−3))/(480*10³*4096)=214 μs (2)

According to an embodiment for the DL 2CC CA case with carrier combination (15 KHz carrier0+120 KHz carrier1), the UE's PDSCH processing time scellₘCAT_{proc,1} may be calculated as below:
For 15 KHz carrier0, μ=0, N₁=14, the UE's PDSCH processing time T_{proc,1_c0} may be calculated as below:

T_{proc,1_c0}=(14*(2048+144)*64*2\hat{ }(0))/(480*10³*4096)=999 μs (3)
For 120 KHz carrier1, μ=3, N₁=24, the UE's PDSCH processing time T_{proc,1_c1} may be calculated as below:

T_{proc,1_c1}=(24*(2048+144)*64*2\hat{ }(−3))/(480*10³*4096)=214 μs (4)
For the carrier combination (15 KHz carrier0+120 KHz carrier1), the UE's PDSCH processing time scellₘCAT_{proc,1} (where in is an index of the carrier combination and/or an index of the Scell in the carrier combination) may be calculated as below:

scellₘCAT_{proc,1}=max(999,214) μs=999 μs (5)

According to the UE's PDSCH processing time, the gNB may calculate the minimum number of slots from downlink scheduling of the UE to uplink feedback to the downlink scheduling by the UE, i.e. the minimum K1 (also called minK1 for short), for both non-CA case and CA case.

In accordance with an exemplary embodiment, minK1 for the non-CA case, K1_{nonCA}, may be calculated so that K1_{nonCA} can fulfill formula (6), and minK1 for the CA case, K1_{CAscell_m}, may be calculated so that K1_{CAscell_m} can fulfill formula (7).

(K1_{nonCA}−1)*Pcell symbol number in one slot*Pcell one symbol duration>=nonCAT_{proc,1} (6)

(K1_{CAscell_m}−1)*Pcell symbol number in one slot*Pcell one symbol duration>=scellₘCAT_{proc,1} (7)

According to an embodiment for 120 KHz, one slot is 0.125 ms with 14 symbols, and thus 214 μs may correspond to 25 symbols and 999 μs may correspond to 113 symbols. Then minK1 for the non-CA case K1_{nonCA} and minK1 for the CA case K1_{CAscell_m} may be calculated as below.

(K1_{nonCA}−1)*14>=25→non-CA case: K1_{nonCA}>=3 (8)

(K1_{CAscell_m}−1)*14>=113→CA case: K1_{CAscell_m}>=10 (9)

Table 3 shows the comparison between minK1 for non-CA case and CA case.

TABLE 3

| Comparison | minK1 |
|---|---|
| 120 KHz (non-CA case) | 3 |
| 120 KHz + 15 KHz DL CA case (Pcell on 120 KHz) | 10 |

According to the comparison given in Table 3, it can be seen that when applying CA such as (120 KHz+15 KHz) DL CA, minK1 is enlarged from 3 to 10 for 120 KHz numerology carrier.

In accordance with an exemplary embodiment, the gNB may adjust minK1 according to associated frame pattern for both non-CA case and CA case. Since only UL slot may be used to send DL HARQ bit back to the gNB, minK1 may be adjusted according to TDD pattern, so as to make sure that minK1 is valid in TDD pattern.

In an embodiment, a minK1 adjustment procedure for non-CA case may be performed for each Pcell's UL slot in one frame pattern. According to the adjustment procedure, if the index which is smaller by K1_{nonCA} than the index “ULslotN” of the Pcell's UL slot points to a DL slot, the minK1 for non-CA case K1_{nonCA} may not be adjusted, and the adjustment procedure may end. If the index which is smaller by K1_{nonCA} than the index “ULslotN” of the Pcell's UL slot points to an UL slot, then K1_{nonCA} may be adjusted by increasing K1_{nonCA} by 1. The adjustment procedure may be repeated with the adjusted K1_{nonCA} in each loop, until it is determined that there is no need to adjust K1_{nonCA}.

Similarly, in another embodiment, a minK1 adjustment procedure for CA case may be performed for each Pcell's UL slot in one frame pattern. According to the adjustment procedure, if the index which is smaller by K1_{CAscel_m} than the index “ULslotN” of the Pcell's UL slot points to a DL slot, the minK1 for CA case K1_{CAscel_m} may not be adjusted, and the adjustment procedure may end. If the index which is smaller by K1_{CAscel_m} than the index “ULslotN” of the Pcell's UL slot points to an UL slot, then K1_{CAscel_m} may be adjusted by increasing K1_{CAscel_m} by 1. The adjustment procedure may be repeated with the adjusted K1_{CAscel_m} in each loop, until it is determined that there is no need to adjust K1_{CAscel_m}.

FIG. 3 is a diagram illustrating exemplary feedback configuration adjustment according to an embodiment of the present disclosure. In the TDD pattern with DDDU configuration as shown in FIG. 3, if minK1=4 (either for non-CA case or CA case), but the index smaller by minK1 than the index of the Pcell's UL slot points to an UL slot, then the actual valid minK1 is 5, which means that minK1 is adjusted from 4 to 5. It can be appreciated that the frame pattern shown in FIG. 3 is just an example, and other suitable frame pattern may be applied in various embodiments according to the present disclosure.

In accordance with an exemplary embodiment, the gNB may prioritize all available Scell candidates by minK1. For example, the gNB may calculate minK1 for all carrier combinations of Pcell and one or more Scell candidates, and sort the Scell candidates (or carrier combinations) by the corresponding values of minK1, e.g., in a Scell candidate list. Then the gNB may determine or select a Scell from the Scell candidate list, according to a specific criterion. In an embodiment, the gNB may select the Scell with the lowest minK1 value in the Scell list. In another embodiment, the gNB may select the Scell with a minK1 value lower than a threshold minK1__{threshold} from the Scell list. If the gNB can support more CCs, then several Scells may be selected from the Scell list.

In accordance with an exemplary embodiment, the gNB may determine whether to select one or more Scells according to a control parameter. For example, if the control parameter is set to enable the Scell selection, then the gNB may select a Scell with a lower minK1 value from the Scell list. If the control parameter is set to disable the Scell selection, then the gNB may not select a Scell from the Scell list.

In accordance with an exemplary embodiment, if the difference between minK1 for nonCA case and minK1 for CA case is larger than a specific value, the gNB may not configure CA at all. In this case, the gNB may not select a Scell from the Scell list. Alternatively or additionally, if the difference between minK1 for nonCA case and minK1 for CA case is less than another specific value, the gNB may select a Scell from the Scell list and configure CA correspondingly.

In accordance with an exemplary embodiment, the gNB may maintain a Scell list. After the UE sets up a connection with the gNB, the gNB may select one or more Scells from the Scell list according to the UE's traffic type. For example, if the UE requires low latency data (e.g., which may be indicated by QoS requirements, etc.) for a long time (e.g., about one or more seconds, etc.), then the gNB may select a Scell with a lower minK1 or no Scell for the UE.

In accordance with an exemplary embodiment, the selected Scell(s) may be configured for the UE by RRC signaling. As an example, the Scell may be configured, e.g. as described in 3GPP TS 38.331 V16.1.0 (where the entire content of this technical specification is incorporated into the present disclosure by reference), by RRC Reconfiguration as below:
CellGroupConfig->sCellToAddModList/ScellConfig->sCellConfigCommon/ServingCellConfigCommon & sCellConfigDedicated/ServingCellConfig.

In accordance with an exemplary embodiment, one or more Scells may be selected from a set of configured Scells in CA, e.g., according to the corresponding minK1 values. In this case, the selected Scell(s) may be activated or deactivated for the UE. As an example, the gNB may decide whether to activate or deactivate the configured Scell for the UE, e.g., as described in 3GPP TS 38.321 V16.1.0 (where the entire content of this technical specification is incorporated into the present disclosure by reference), by the Scell Activation/Deactivation MAC CE.

In accordance with an exemplary embodiment, if the Scell may bring larger minK1 for CA compared with the case of Pcell only, then a large-latency activation flag may be set or maintained to true. According to an embodiment, the gNB may not activate a Scell for the UE if the large-latency activation flag is true. According to another embodiment, the gNB may not activate a Scell or may deactivate a Scell, if the large-latency activation flag is true for a UE which may require low latency data during a period time (e.g., several transmission time intervals (TTIs), or tens to hundreds of milliseconds, etc.).

In accordance with an exemplary embodiment, one or more Scells may be selected from a set of activated Scells in CA, e.g., according to the corresponding minK1 values. In this case, the selected Scell(s) may be scheduled for the UE. As an example, the gNB may decide how to schedule the Pcell and the Scell, and send scheduling information to the UE by DCI.

In accordance with an exemplary embodiment, if the Scell may bring larger minK1 for CA compared with the case of Pcell only, then a large-latency scheduling flag may be set or maintained to true. According to an embodiment, the gNB may not schedule a Scell for the UE if the large-latency scheduling flag is true. According to another embodiment, the gNB may not schedule a Scell, if the large-latency scheduling flag is true for a UE which may require low latency data for this scheduling TTI.

It can be appreciated that the parameter names (e.g., nonCAT_{proc,1}, scellₘCAT_{proc,1}, K1_{nonCA}, K1_{CAscell_m}, minK1, etc.) and the threshold (e.g., minK1__{threshold}) used herein are exemplary, and other parameter names and thresholds may also be used to indicate the same or similar information. In addition, it can be appreciated that algorithms, functions and variables related to the determination of HARQ latency as described in connection with formulas (1)˜(9) and FIG. 3 are just examples, and other suitable algorithms, functions, variables and the associated values thereof may also be applicable for implementing the proposed methods.

It is noted that some embodiments of the present disclosure are mainly described in relation to 5G or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

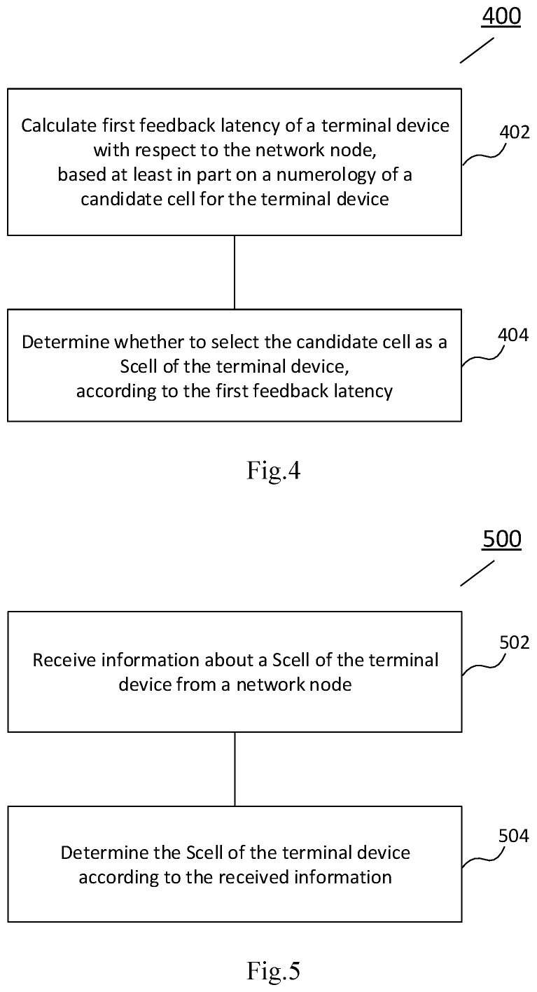

FIG. 4 is a flowchart illustrating a method 400 according to some embodiments of the present disclosure. The method 400 illustrated in FIG. 4 may be performed by a network node or an apparatus communicatively coupled to the network node. In accordance with an exemplary embodiment, the network node may comprise a base station, an AP, a transmission point or any other suitable entity that may be capable of serving one or more terminal devices such as UEs according to specific communication protocols.

According to the exemplary method 400 illustrated in FIG. 4, the network node may calculate first feedback latency of a terminal device with respect to the network node, based at least in part on a numerology of a candidate cell for the terminal device, as shown in block 402. According to the first feedback latency, the network node may determine whether to select the candidate cell as a Scell of the terminal device, as shown in block 404. In an embodiment, the selection of the Scell may comprise selection of one or more carriers/carrier combinations for the terminal device.

In accordance with an exemplary embodiment, the first feedback latency may correspond to a carrier combination of the candidate cell and a Pcell of the terminal device. For example, the first feedback latency may be indicated by one or more parameters such as scellₘCAT_{proc,1}, K1_{CAscell_m}, etc.

In accordance with an exemplary embodiment, the first feedback latency may be further based at least in part on one or more of: a numerology of a Pcell of the terminal device; a frame pattern (e.g., TDD/FDD pattern) for the terminal device; and a capability of the terminal device.

In accordance with an exemplary embodiment, the calculation of the first feedback latency may comprise estimating downlink channel processing time of the terminal device, according to the numerology of the candidate cell and a numerology of a Pcell of the terminal device. Then the first feedback latency may be calculated according to the downlink channel processing time of the terminal device. In an embodiment, the first feedback latency may be adjusted according to a frame pattern for the terminal device, e.g., as described with respect to FIG. 3.

In accordance with an exemplary embodiment, the first feedback latency may be equal to a minimum number of slots from downlink scheduling of the terminal device by the network node to uplink feedback to the downlink scheduling by the terminal device, e.g. minK1 as described with respect to Table 3 and FIG. 2.

In accordance with an exemplary embodiment, the candidate cell may be included in a cell list for the terminal device according to the first feedback latency. For example, various candidate cells in the cell list may be sorted in ascending or descending order of the corresponding feedback latency values.

In accordance with an exemplary embodiment, the network node may determine to select the candidate cell as the Scell of the terminal device, in response to the first feedback latency meeting one or more of the following criterions:
the first feedback latency is lower than feedback latencies of the terminal device calculated for one or more cells different from the candidate cell;
the first feedback latency is lower than a first threshold (e.g., a predetermined threshold of feedback latency, or a dynamic threshold determined according to the smallest and/or second smallest feedback latency corresponding to candidate cells in the cell list, etc.); and
a difference between second feedback latency of the terminal device calculated for a Pcell of the terminal device and the first feedback latency is lower than a second threshold (e.g., a fixed or dynamic threshold determined according to different network configurations and/or service requirements, etc.).

In accordance with an exemplary embodiment, selecting the candidate cell as the Scell of the terminal device may comprise configuring the candidate cell as the Scell of the terminal device. In an embodiment, the candidate cell may be configured as the Scell of the terminal device according to one or more of:
a first parameter to enable/disable Scell configuration for the terminal device;
a traffic type of the terminal device; and
a QoS requirement of the terminal device during a first period of time (e.g., a relative long time period such as one or more seconds, etc.).

In accordance with an exemplary embodiment, the candidate cell may be one of cells configured for the terminal device. In this case, selecting the candidate cell as the Scell of the terminal device may comprise activating the candidate cell as the Scell of the terminal device. In an embodiment, the candidate cell may be activated as the Scell of the terminal device according to one or more of:
a second parameter to enable/disable Scell activation for the terminal device;
a traffic type of the terminal device; and
a QoS requirement of the terminal device during a second period of time (e.g., a relative short time period such as one or more TTIs, etc.).

In accordance with an exemplary embodiment, the candidate cell may be one of cells activated for the terminal device. In this case, selecting the candidate cell as the Scell of the terminal device may comprise scheduling the candidate cell as the Scell of the terminal device. In an embodiment, the candidate cell may be scheduled as the Scell of the terminal device according to one or more of:
a third parameter to enable/disable Scell scheduling for the terminal device;
a traffic type of the terminal device; and
a QoS requirement of the terminal device during a third period of time (e.g., a very short time period such as a scheduling TTI, etc.).

In accordance with an exemplary embodiment, the network node may transmit information about the Scell to the terminal device. For example, the information about the Scell may include Scell configuration information, Scell activation information and/or Scell scheduling information, etc. According to an embodiment, the information about the Scell may be transmitted to the terminal device in a RRC message, a MAC CE and/or DCI.

In accordance with an exemplary embodiment, the network node may select one or more other candidate cells as Scells of the terminal device, according to feedback latencies of the terminal device which may be calculated based at least in part on numerologies of the one or more other candidate cells. Correspondingly, the network node may transmit information about the selected Scells to the terminal device.

FIG. 5 is a flowchart illustrating a method 500 according to some embodiments of the present disclosure. The method 500 illustrated in FIG. 5 may be performed by a terminal device or an apparatus communicatively coupled to the terminal device. In accordance with an exemplary embodiment, the terminal device such as a UE may be capable of communicating with a network node (e.g., a base station, an AP, a transmission point, etc.) according to specific communication protocols.

According to the exemplary method 500 illustrated in FIG. 5, the terminal device may receive information about a Scell of the terminal device from a network node (e.g., the network node as described with respect to FIG. 4), as shown in block 502. In accordance with an exemplary embodiment, the Scell may be selected for the terminal device by the network node according to first feedback latency of the terminal device with respect to the network node. The first feedback latency may be based at least in part on a numerology of the Scell. According to the received information, the terminal device may determine the Scell of the terminal device, as shown in block 504.

It can be appreciated that the steps, operations and related configurations of the method 500 illustrated in FIG. 5 may be correspond to the steps, operations and related configurations of the method 400 illustrated in FIG. 4. It also can be appreciated that the first feedback latency as described with respect to FIG. 5 may correspond to the first feedback latency as described with respect to FIG. 4. Thus, the first feedback latency as described with respect to the method 500 and method 400 may have the same or similar contents and feature elements. Similarly, the information about the Scell of the terminal device as described with respect to FIG. 5 may correspond to the information about the Scell of the terminal device as described with respect to FIG. 4.

In accordance with an exemplary embodiment, the first feedback latency may be related to downlink channel processing time of the terminal device. As described with respect to FIG. 4, the downlink channel processing time may be determined based at least in part on the numerology of the S cell and a numerology of a Pcell of the terminal device.

In accordance with an exemplary embodiment, the information about the Scell may indicate that the Scell is configured for the terminal device by the network node. In an embodiment, the configuration of the Scell for the terminal device may be according to a first parameter to enable/disable Scell configuration for the terminal device, a traffic type of the terminal device, and/or a QoS requirement of the terminal device during a first period of time.

In accordance with an exemplary embodiment, the Scell may be one of cells configured for the terminal device. In this case, the information about the Scell may indicate that the Scell is activated for the terminal device by the network node. In an embodiment, the activation of the Scell for the terminal device may be according to a second parameter to enable/disable Scell activation for the terminal device, a traffic type of the terminal device, and/or a QoS requirement of the terminal device during a second period of time.

In accordance with an exemplary embodiment, the Scell may be one of cells activated for the terminal device. In this case, the information about the Scell may indicate that the Scell is scheduled for the terminal device by the network node. In an embodiment, the scheduling of the Scell for the terminal device may be according to a third parameter to enable/disable Scell scheduling for the terminal device, a traffic type of the terminal device, and/or a QoS requirement of the terminal device during a third period of time.

In accordance with an exemplary embodiment, the information about the Scell may be received by the terminal device in one or more of: a RRC message, a MAC CE, and DCI. According to an exemplary embodiment, the information about the Scell may also be related to one or more other Scells of the terminal device. The one or more other Scells may be selected for the terminal device by the network node according to feedback latencies of the terminal device which may be based at least in part on numerologies of the one or more other Scells.

Various exemplary embodiments according to the present disclosure may enable carrier combination or carrier aggregation to be controlled adaptively. In accordance with some exemplary embodiments, a gNB may select one or more Scells for a UE, e.g., according to feedback latency of the UE. For example, the gNB may calculate HARQ latency (e.g., minK1, etc.) for each Scell according to the numerology and potentially frame pattern (e.g. FDD/TDD pattern) of both Pcell and Scell. Then the gNB may prioritize all available Scell candidates by minK1 in a Scell candidate list, and determine which Scell(s) to select from the Scell candidate list. The Scell selection according to various embodiments may be applied to implement Scell configuration, Scell activation and/or Scell scheduling for the UE. In an embodiment, the selected Scell(s) from the Scell candidates may be configured for the UE. Alternatively or additionally, one or more Scells selected from the configured cells may be activated for the UE. It can be appreciated that the configured Scell may also be determined based on other suitable schemes in addition or alternative to the HARQ latency. Alternatively or additionally, one or more Scells selected from the activated cells may be scheduled for the UE. It also can be appreciated that the activated Scell may also be determined based on other suitable schemes in addition or alternative to the HARQ latency. In an embodiment, a Scell which may cause higher HARQ delay may not be configured for a UE which may only have low latency traffic. In another embodiment, a Scell which may cause higher HARQ delay may not be activated for a UE which may have low latency traffic occasionally. In a further embodiment, a Scell which may cause higher HARQ delay may not be scheduled for a UE which may once have low latency traffic. Application of various exemplary embodiments can advantageously improve network performance and resource efficiency, and enhance flexibility of carrier combination configuration and CA implementation.

The various blocks shown in FIGS. 4-5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

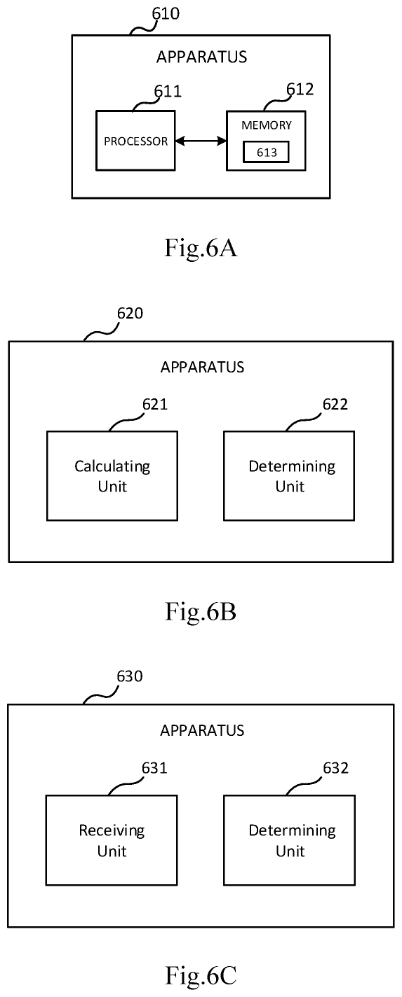

FIG. 6A is a block diagram illustrating an apparatus 610 according to various embodiments of the present disclosure. As shown in FIG. 6A, the apparatus 610 may comprise one or more processors such as processor 611 and one or more memories such as memory 612 storing computer program codes 613. The memory 612 may be non-transitory machine/processor/computer readable storage medium. In accordance with some exemplary embodiments, the apparatus 610 may be implemented as an integrated circuit chip or module that can be plugged or installed into a network node as described with respect to FIG. 4, or a terminal device as described with respect to FIG. 5. In such case, the apparatus 610 may be implemented as a network node as described with respect to FIG. 4, or a terminal device as described with respect to FIG. 5.

In some implementations, the one or more memories 612 and the computer program codes 613 may be configured to, with the one or more processors 611, cause the apparatus 610 at least to perform any operation of the method as described in connection with FIG. 4. In other implementations, the one or more memories 612 and the computer program codes 613 may be configured to, with the one or more processors 611, cause the apparatus 610 at least to perform any operation of the method as described in connection with FIG. 5. Alternatively or additionally, the one or more memories 612 and the computer program codes 613 may be configured to, with the one or more processors 611, cause the apparatus 610 at least to perform more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a calculating unit 621 and a determining unit 622. In an exemplary embodiment, the apparatus 620 may be implemented in a network node such as a base station. The calculating unit 621 may be operable to carry out the operation in block 402, and the determining unit 622 may be operable to carry out the operation in block 404. Optionally, the calculating unit 621 and/or the determining unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise a receiving unit 631 and a determining unit 632. In an exemplary embodiment, the apparatus 630 may be implemented in a terminal device such as a UE. The receiving unit 631 may be operable to carry out the operation in block 502, and the determining unit 632 may be operable to carry out the operation in block 504. Optionally, the receiving unit 631 and/or the determining unit 632 may be operable to carry out more or less operations to implement the proposed methods according to the exemplary embodiments of the present disclosure.

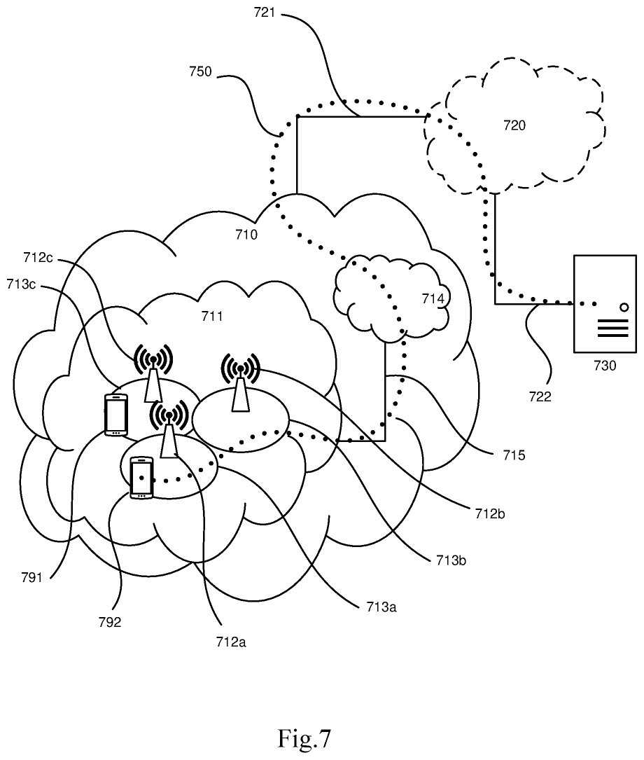

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

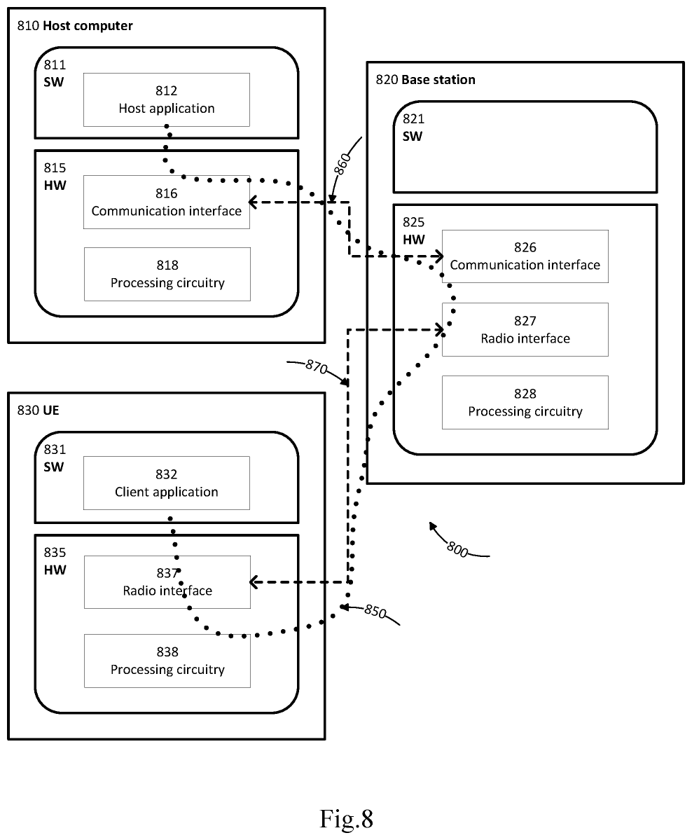

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

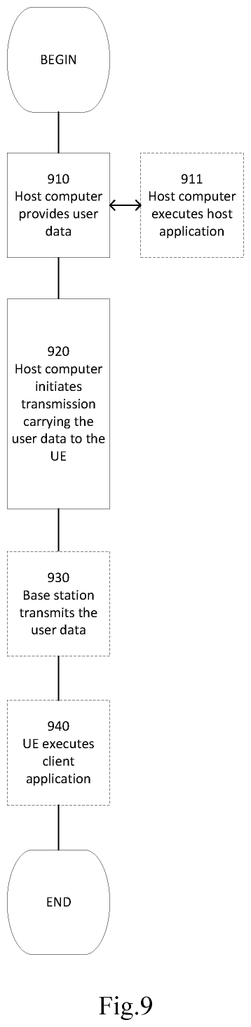

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

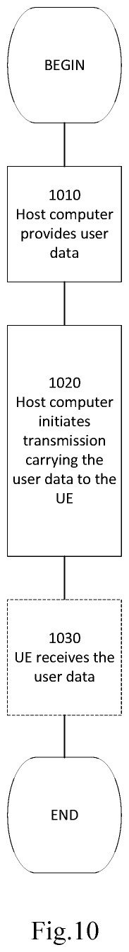

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

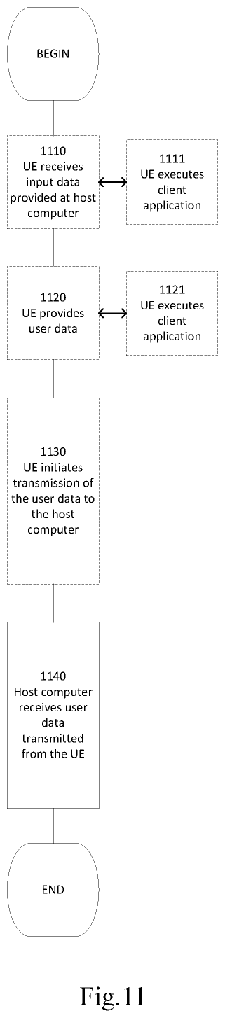

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

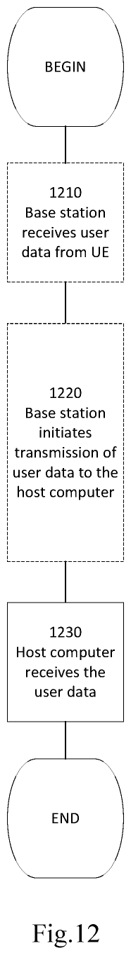

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 400 as describe with respect to FIG. 4.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 400 as describe with respect to FIG. 4.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 500 as describe with respect to FIG. 5.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 500 as describe with respect to FIG. 5.

According to some exemplary embodiments, there is provided a method implemented in a communication system which may include a host computer, a base station and a UE. The method may comprise, at the host computer, receiving user data transmitted to the base station from the UE which may perform any step of the exemplary method 500 as describe with respect to FIG. 5.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 500 as describe with respect to FIG. 5.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 400 as describe with respect to FIG. 4.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 400 as describe with respect to FIG. 4.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a network node, comprising:
calculating first feedback latency of a terminal device with respect to the network node, based at least in part on a numerology of a candidate cell for the terminal device; and
determining whether to select the candidate cell as a secondary cell of the terminal device, according to the first feedback latency.

2. The method according to claim 1, wherein the first feedback latency corresponds to a carrier combination of the candidate cell and a primary cell of the terminal device.

3. The method according to claim 1, wherein the first feedback latency is further based at least in part on one or more of:
a numerology of a primary cell of the terminal device;
a frame pattern for the terminal device; and
a capability of the terminal device.

4. The method according to claim 1, wherein the calculation of the first feedback latency comprises:
estimating downlink channel processing time of the terminal device, according to the numerology of the candidate cell and a numerology of a primary cell of the terminal device; and
calculating the first feedback latency according to the downlink channel processing time of the terminal device.

5. The method according to claim 4, wherein the first feedback latency is adjusted according to a frame pattern for the terminal device.

6. The method according to claim 1, wherein the first feedback latency is equal to a minimum number of slots from downlink scheduling of the terminal device by the network node to uplink feedback to the downlink scheduling by the terminal device.

7. The method according to claim 1, wherein the candidate cell is included in a cell list for the terminal device according to the first feedback latency.

8. The method according to claim 1, wherein the network node determines to select the candidate cell as the secondary cell of the terminal device, in response to the first feedback latency meeting one or more of:
the first feedback latency is lower than feedback latencies of the terminal device calculated for one or more cells different from the candidate cell;
the first feedback latency is lower than a first threshold; and
a difference between second feedback latency of the terminal device calculated for a primary cell of the terminal device and the first feedback latency is lower than a second threshold.

9. The method according to claim 8, wherein selecting the candidate cell as the secondary cell of the terminal device comprises:
configuring the candidate cell as the secondary cell of the terminal device;
wherein the candidate cell is configured as the secondary cell of the terminal device according to one or more of:
a first parameter to enable secondary cell configuration for the terminal device;
a traffic type of the terminal device; and
a quality of service requirement of the terminal device during a first period of time.

10. (canceled)

11. The method according to claim 8, wherein the candidate cell is one of cells configured for the terminal device, and wherein selecting the candidate cell as the secondary cell of the terminal device comprises:
activating the candidate cell as the secondary cell of the terminal device;
wherein the candidate cell is activated as the secondary cell of the terminal device according to one or more of:
a second parameter to enable secondary cell activation for the terminal device;
a traffic type of the terminal device; and
a quality of service requirement of the terminal device during a second period of time.

12. (canceled)

13. The method according to claim 8, wherein the candidate cell is one of cells activated for the terminal device, and wherein selecting the candidate cell as the secondary cell of the terminal device comprises:
scheduling the candidate cell as the secondary cell of the terminal device;
wherein the candidate cell is scheduled as the secondary cell of the terminal device according to one or more of:
a third parameter to enable secondary cell scheduling for the terminal device;
a traffic type of the terminal device; and
a quality of service requirement of the terminal device during a third period of time.

14. (canceled)

15. The method according to claim 8, further comprising:
transmitting information about the secondary cell to the terminal device;
wherein the information about the secondary cell is transmitted to the terminal device in one or more of:
a radio resource control message;
a control element for medium access control; and
downlink control information.

16. (canceled)

17. The method according to claim 1, further comprising:
selecting one or more other candidate cells as secondary cells of the terminal device, according to feedback latencies of the terminal device which are calculated based at least in part on numerologies of the one or more other candidate cells.

18. A network node, comprising:
one or more processors; and
one or more memories comprising computer program codes,
the one or more memories and the computer program codes configured to, with the one or more processors, cause the network node at least to:
calculate first feedback latency of a terminal device with respect to the network node, based at least in part on a numerology of a candidate cell for the terminal device; and
determine whether to select the candidate cell as a secondary cell of the terminal device, according to the first feedback latency.

19. (canceled)

20. (canceled)

21. A method performed by a terminal device, comprising:
receiving information about a secondary cell of the terminal device from a network node, wherein the secondary cell is selected for the terminal device by the network node according to first feedback latency of the terminal device with respect to the network node, and the first feedback latency is based at least in part on a numerology of the secondary cell; and
determining the secondary cell of the terminal device according to the received information.

22. The method according to claim 21, wherein the first feedback latency corresponds to a carrier combination of the secondary cell and a primary cell of the terminal device.

23. The method according to claim 21, wherein the first feedback latency is further based at least in part on one or more of:
a numerology of a primary cell of the terminal device;
a frame pattern for the terminal device; and
a capability of the terminal device.

24. The method according to claim 21, wherein the first feedback latency is related to downlink channel processing time of the terminal device, and wherein the downlink channel processing time is based at least in part on the numerology of the secondary cell and a numerology of a primary cell of the terminal device.

25. The method according to claim 21, wherein the first feedback latency is equal to a minimum number of slots from downlink scheduling of the terminal device by the network node to uplink feedback to the downlink scheduling by the terminal device.

26. The method according to claim 21, wherein the first feedback latency meets one or more of:
the first feedback latency is lower than feedback latencies of the terminal device calculated for one or more cells different from the secondary cell;
the first feedback latency is lower than a first threshold; and
a difference between second feedback latency of the terminal device calculated for a primary cell of the terminal device and the first feedback latency is lower than a second threshold.

27-53. (canceled)
